(19) United States
(12) Patent Application Publication
(10) Pub. No.: US 2007/0189732 A1
(43) Pub. Date: Aug. 16, 2007

(54) System and method for reconstructing MPEG-2 start codes from AVC data

(76) Inventors: Sai Pothana, Sunnyvale, CA (US); Yasantha Rajakarunanayake, San Ramon, CA (US)

Correspondence Address: MCANDREWS HELD & MALLOY, LTD, 500 WEST MADISON STREET, SUITE 3400, CHICAGO, IL, 60661, US

(21) Appl. No.: 11/351,584

(22) Filed: Feb. 10, 2006

(51) Int. Cl. H04N 7/26

(52) U.S. Cl. 386/112

(57) ABSTRACT

Presented herein are systems and methods for reconstructing MPEG-2 compatible start codes from AVC data. MPEG-4 AVC stream formats are complex, and embedded in NAL units often requiring several VLD (variable length decodes) to determine the beginning of the picture. An AVC index table is created to enable efficient AVC Personal Video Recording based on the bits that are captured from the AVC stream.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

JVT is a collective partnership between the Video Coding Experts Group (VCEG) and MPEG. AVC is also known as ITU-T H.264, ISO/IEC MPEG-4 Part 10, ISO/IEC 14496-10, and JVT codec. For example, the 128-bit MPEG-2 start code may indicate PVR playback options. An AVC start code may contain 192 bits, and is therefore unsuitable for PVR applications that are based on the MPEG-2 format.

Personal Video Recording (PVR) applications may use MPEG-2 or AVC to digitally record live TV programs while offering special playback features (trick mode features). During playback the viewer can use of trick mode features such as pause, fast forward, slow forward, rewind, slow reverse, and frame advance.

Recording a digitally compressed stream to storage and playing it back at a later time uses an extension to standard live decode where specialized control is included in the decoder. Therefore, trick mode support of an AVC broadcast introduces additional complexities. The AVC decoder would determine where pictures are in the stream before the program is decoded, adding complications that must be addressed.

Limitations and disadvantages of conventional and traditional approaches will become apparent to one of skill in the art, through comparison of such systems with some aspects of the present invention as set forth in the present application with reference to the drawings.

### BRIEF SUMMARY OF THE INVENTION

Aspects of the present invention may be found in a personal video recorder that is compatible with the Advanced Video Coding standard and the MPEG-2 standard.

These and other advantages, aspects and novel features of the present invention, as well as details of an illustrated embodiment thereof, will be more fully understood from the following description and drawings.

### BRIEF DESCRIPTION OF THE DRAWINGS

FIG. 1 is a flowchart illustrating an exemplary method for constructing an AVC start code table in accordance with a representative embodiment of the present invention;

FIG. 2 is a flowchart illustrating an exemplary method for parsing a start code table entry based on an AVC stream in accordance with a representative embodiment of the present invention;

FIG. 3A is a flowchart illustrating an exemplary method for determining if each picture is an I, P, or B picture in accordance with a representative embodiment of the present invention;

FIG. 3B is a flowchart illustrating an exemplary method for determining the appropriate SPS and PSP data that accompanies every slice in accordance with a representative embodiment of the present invention;

FIG. 4 is a diagram illustrating an exemplary NAL Unit in accordance with a representative embodiment of the present invention;

FIG. 5 is a diagram illustrating an exemplary Slice Header in accordance with a representative embodiment of the present invention;

FIG. 6 is a diagram illustrating an exemplary Sequence Parameter Set in accordance with a representative embodiment of the present invention;

FIG. 7 is a diagram illustrating an exemplary Picture Parameter Set in accordance with a representative embodiment of the present invention;

FIG. 8 is a diagram illustrating an exemplary Access Unit Delimiter in accordance with a representative embodiment of the present invention; and

FIG. 9 is a diagram illustrating an exemplary system for constructing an AVC start code table in accordance with a representative embodiment of the present invention.

### DETAILED DESCRIPTION OF THE INVENTION

The host may manipulate a recorded stream to create the visual effect of a playback function trick mode. For example, pictures can be dropped cleanly in the stream to cause the visual effect of a fast forward. An advantage of host trick modes is that visual responses can be implemented (fast forward, rewind, frame advance, etc.). For this reason host trick modes are the most commonly implemented trick modes, and many PVRs support only host trick modes.

A disadvantage of host trick modes is that they may require the decoder to parse the stream at record time to determine picture location and picture type. This adds complications to the decoder, particularly when AVC content is broadcast. This parsing also assumes that the decoder has access to the fields in the bit stream it needs to parse.

For MPEG-2 content, streams are parsed while they are being recorded and an index table is created for start codes in the bit stream. The exact start codes that are flagged are programmable in a start code detection circuit and are typically configured to flag all non-slice start codes. Specific picture information, such as picture type, may be included in the index table.

An MPEG-2 start code table may be created by: 1) capturing the 96 bits after detecting the flag that indicates the start of start code entry; 2.) entering the first 32 bits according to the in the MPEG-2 standard (e.g. FRAME TYPE, PTS, PES, SEQUENCE INFORMATION); and 3.) storing the remaining bits as offsets into the video data stream.

At playback of the MPEG-2 content, the host uses the start code table entries to monitor what picture types (I frames, P frames, and/or B frames) exist in the stream and where they are located. For high speed fast forward and rewind, the host grabs a number of I frames and feeds the I frames into the decoder. The ratio of I frames grabbed to I frames dropped depends on the fast forward/rewind speed and the Group of Picture (GOP) size. Since I frames do not include temporal prediction, I frames are decoded and displayed without requiring additional frames. For slower fast forward, the host may keep some or all of the P frames and drop only B frames.

Indexing an AVC stream for PVR presents several challenges beyond MPEG-2. In AVC streams:
B frames may be used for prediction
P frames may predict in either temporal direction
One frame may use multiple reference frames
Access unit delimiters are optional
Many parameters are VLC encoded

The indexing logic in the record path may access data from the AVC transport stream at record time to address these issues. An AVC index table may contain the fields as shown in Table 1.

TABLE 1
Fields for AVC Index Tables

| Field Name | Size | Location in Stream |
|---|---|---|
| nal_ref_idc | 2 bits | NAL Header |
| nal_unit type | 5 bits | NAL Header |
| first_mb_in_slice | variable length | Slice Header |
| | (1-27 bits) | |
| slice_type | variable length | Slice Header |
| | (1-7 bits) | |
| seq_parameter_set_id | variable_length | Two Locations: |

| | | |
|---|---|---|
| (1-11 bits) | 1. | Sequence |
| | | Parameter Set |
| | 2. | Picture |
| | | Parameter Set |

| | | |
|---|---|---|
| pic_parameter_set_id | variable_length | Picture Parameter |
| | (1-17 bits) | Set |
| primary_pic_type | 3 bits | Access Unit |
| | | Delimiter |

After these fields are captured, they are preprocessed and stored into an index file that has one entry per NAL unit and contains everything needed to perform trick modes. All the rewind operations may be performed based on I frames entries only, and all forward operation may use either P or I frames. PTS could be used for time based rewind and forward, but after reaching the desired PTS entry, a first I frame entry has to be found either in the forward or backward direction depending upon the rewind or forward operation.

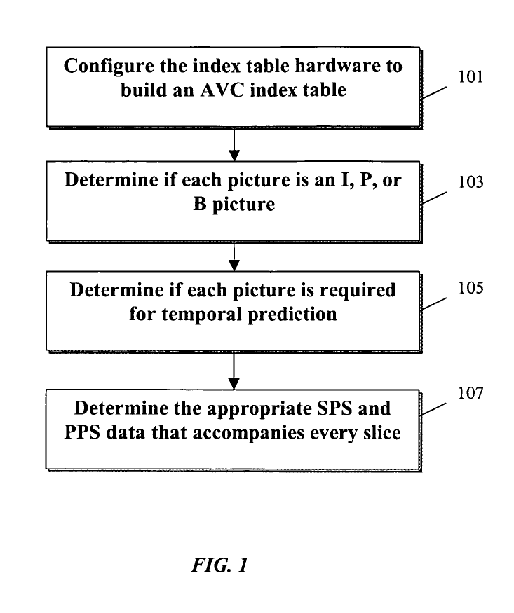

FIG. 1 is a flowchart illustrating an exemplary method for constructing an AVC start code table. The host may perform the following functions with the AVC index table to implement AVC trick modes:

At 101, the index table hardware is configured to build an AVC index table that includes: nal_ref_idc, nal_unit_type, first_mb₁₃ in_slice (or a Boolean flag), slice_type, seq_parameter_set_id, pic_parameter_set_id, and primary_pic_type.

At 103, whether a picture is an I, P, or B picture is determined by checking the slice_type field of the slices in the picture. I pictures contain only I slices. P pictures contain either I or P slices (no B slices). B pictures contain at least one B slice.

At 105, whether a picture is required for temporal prediction is determined by checking the nal_ref_idc field of the first slice. A picture is a reference picture if the first slice in a picture is used as a reference.

At 107, the appropriate SPS and PPS data that accompanies every slice is determined. The pic_parameter_set_id of every slice must be matched up to PPS data that has the same pic_parameter_set_id. Then the seq_parameter_set_id of this PPS is matched up to SPS data that has the same seq_parameter_set_id.

For PVR applications, a host processor may read data, which comprises a frame, from a memory and input that data to a hardware/firmware AVC decoder. However, to access the beginning of the frame, the size of the frame, and the type of the frame (i.e. I, P, B etc. . . . ), the host processor may need to partially decode the NAL layer during playback, and this is unnecessarily complex.

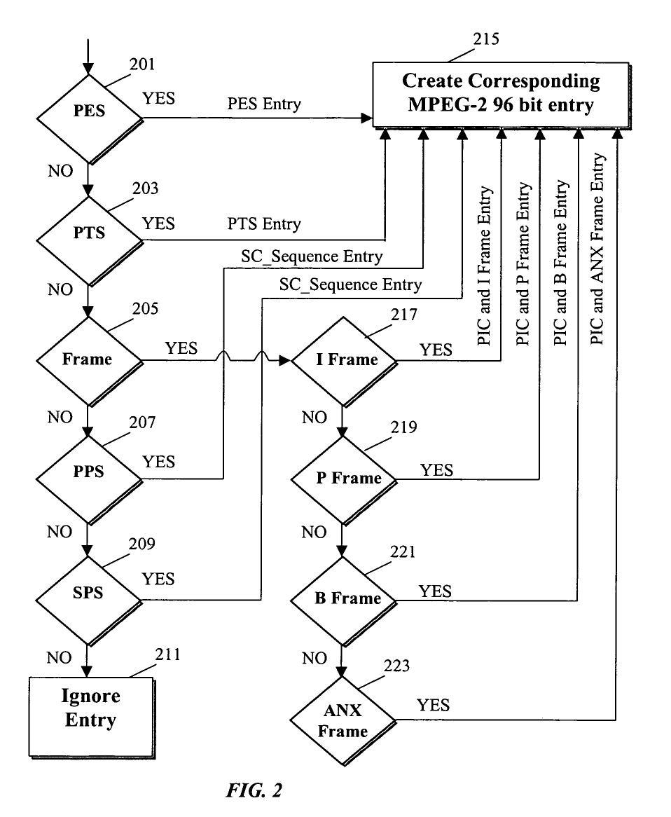

The NAL layer may be decoded prior to playback to create index entries that are reformatted as the MPEG-2 index entries. FIG. 2 is a flowchart illustrating a method for parsing a start code table entry based on an AVC stream.

When a PES entry is present at 201, a corresponding entry may be made in the MPEG-2 table at 215. Likewise when a PTS entry is present at 203 a corresponding entry may be made in the MPEG-2 table at 215. However, MPEG-4 has a split sequence parameter comprising picture parameter set (PPS) and sequence parameter set (SPS), so whenever a PPS entry at 207 or a SPS entry at 209 is detected in an MPEG-4 stream, a corresponding entry may be created with a start code that is equivalent to the MPEG-2 sequence parameter at 215.

If the entry is determined to be a frame at 205, the type of frame is then determined. I frames are determined at 217; P frames are determined at 219; B frames are determined at 221; and ANX frames are determined at 223. If the entry is not PES, PTS, PPS, SPS, or Frame, it is ignored at 211.

By using the MPEG-2 compatible start code table, the PVR user may use trick modes without requiring the host processor to partially decode the NAL layer during playback, and a less complex playback engine may be used for feeding the decoder. With this arrangement, the host processor does not require knowledge of the AVC or variable length decodes. Trick modes may be, for example, skip to any time offset in the stream, play I and P frames only, frame advance, or play one frame at a time.

Reducing complexity during playback is very important because stream parsing at playback time is inefficient and can consume an inordinate amount of code/memory space. If the capability of the host is low (e.g. cell phones, video devices, or low end settop boxes) then having this type of SCT (Start code table) simplifies the frame feeding task.

This is applicable to network applications as well. For example, the start code table can indicate to the host processor to retrieve a particular frame from a web site, and the prefetching/caching of frames will operate faster. The host processor is not required to decode the details of AVC and NAL/PES packetization.

In an alternative embodiment, the stream encoder may provide, in the case of MPEG Transport streams, the preformatted start code information as a separate pid. The record engine can record the stream and the separate startcode pid (which yields the SCT) without any VLD and complex bitwise processing.

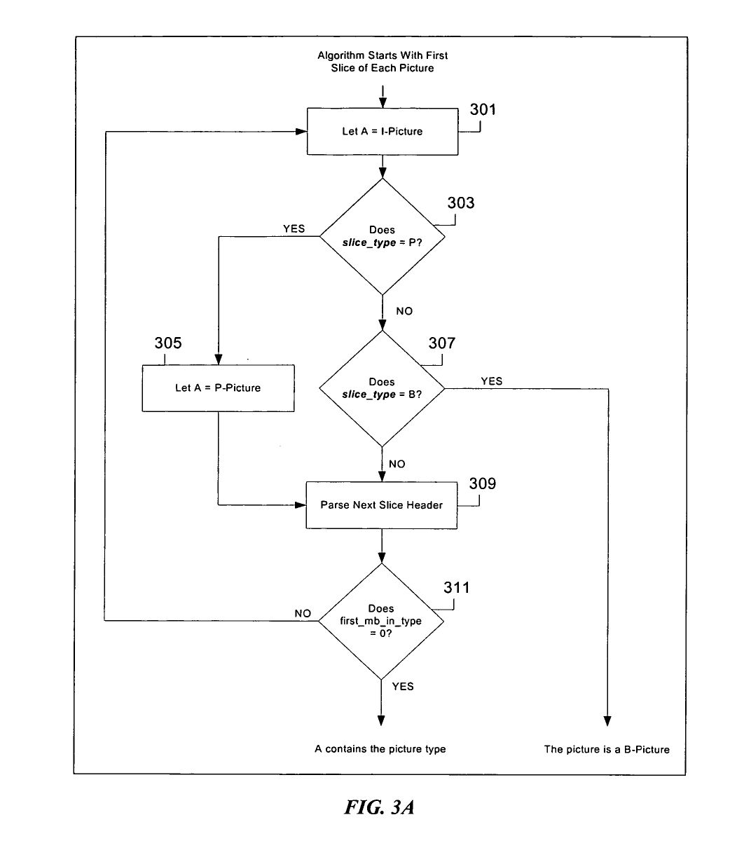

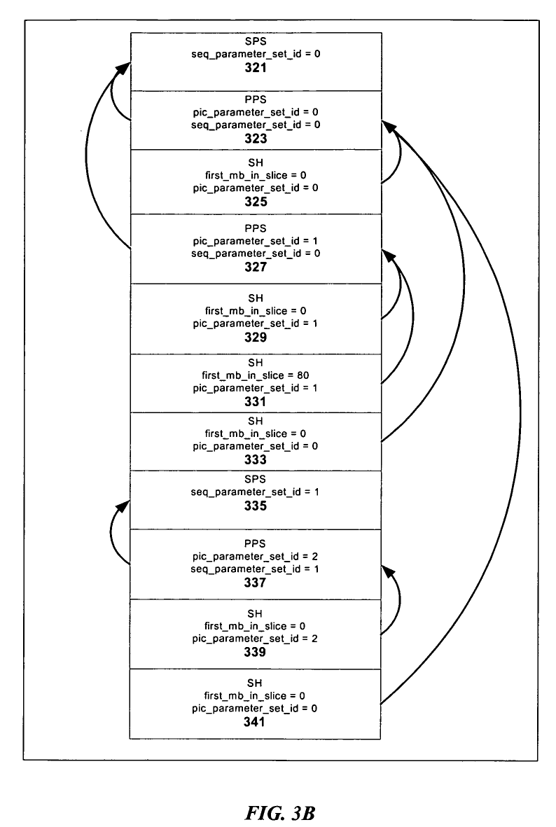

FIG. 3A is a flowchart illustrating an exemplary method for determining if each picture is an I, P, or B picture. The method begins with the first slice of each picture. The I-picture type is assumed at 301. If at 303 the slice_type=P, the picture type is set to P-picture at 305. If at 303 the slice_type does not equal P, slice_type=B is considered at 307. If any slice_type=B, the picture is automatically a B-picture. If the picture is not automatically a B-picture, the next slice header is parsed at 309, and if first_mb_in_type=0 at 311, the picture type is selected. If first_mb_in_type does not equal 0 at 311, the method returns to 301 and the picture type is initially assumed to be an I-picture.

FIG. 3B is a flowchart illustrating an exemplary method for determining the appropriate SPS and PSP data that accompanies every slice. Slice header 325 uses PPS 323 and SPS 321. Slice header 329 uses PPS 327 and SPS 321. Slice header 333 uses PPS 323 and SPS 321. Slice header 339 uses PPS 337 and SPS 335. Slice header 341 uses PPS 323 and SPS 321. Slice header 331 is not considered since first_mb_in_slice does not equal 0. As shown in FIG. 3, the corresponding SPS and/or PPS data may not be located directly before SH data, and SPS and PPS data other than the most recent data in the bitstream may be referenced by SH data. Therefore, the host application keeps track of different PPS and SPS data and is able to resend them should a trick mode cause this information to change.

The fields may be VLC encoded. The Exp-Golomb-coded format as specified in the AVC standard. Every code in the Exp-Golomb format has a length of 2N+1 bits where N can be any nonnegative integer, i.e., N can equal 0, 1, 2, . . . ). The first N bits are referred to as the prefix and each bit is equal to zero. The (N+1) bit is equal to 1 and the last N bits are referred to as the suffix and may be composed of any binary sequence. The unsigned integer value of a codeword is computed as 2^{N}−1+(suffix in binary).

Table 2 illustrates the assignment of codewords to unsigned integer values. For example: i) when the codeword is 1, N=0 and suffix=0 (binary)=0 (decimal) (i.e. value=2⁰−1+0=0); ii) when the codeword is 010, N=1 and suffix=0 (binary)=0 (decimal) (i.e. value=2¹−1+0=1); and iii) when the codeword is 00110, N=2 and suffix=10 (binary)=2 (decimal)(i.e. value=2²−1+2=5. The format of this VLC coding syntax permits decoding by: i) counting how many consecutive bits are zero (this value may be 0) and let N represent this value; ii) reading N bits after the (N+1) bit (which is equal to 1 by definition from the step above) and this is the suffix; and iii) using the value of N and the suffix with the formula, 2^{N}−1+ (suffix in binary), to calculate the unsigned integer coded value. In addition, the number of bits used to represent a certain value X (in decimal) can be computed as follows:
Number of Bits=1+2*floor(log₂(X+1))

TABLE 2
Exp-Golomb VLC Codewords and Their Decoded
Unsigned Integer Values

| | Decoded Unsigned |
|---|---|
| Codeword | Integer Value |
| 1 | 0 |
| 010 | 1 |
| 011 | 2 |
| 00100 | 3 |
| 00101 | 4 |
| 00110 | 5 |
| 00111 | 6 |
| 0001000 | 7 |
| . . . | . . . |

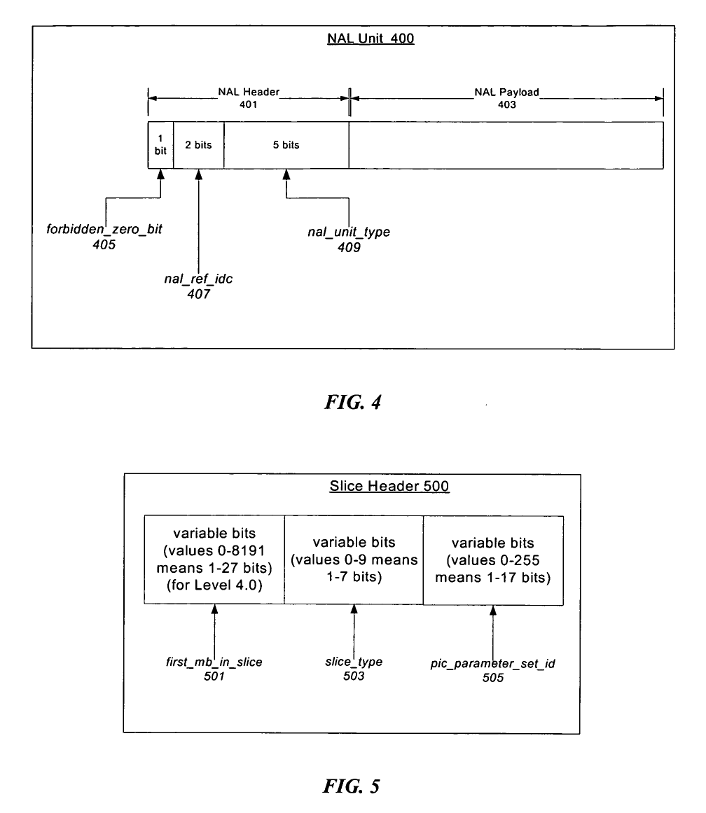

AVC replaces the concept of a start code embedded in the bitstream (as used in MPEG-2) with a NAL (Network Abstraction Layer ). The VCL (Video Coding Layer) is specified to efficiently represent only the video content and does not contain start codes. FIG. 4 is a diagram illustrating an exemplary NAL Unit 400. The NAL is specified to format and packetize VCL data as well as other types of non-VCL data such as SEI data in a fashion similar to MPEG-2 start codes. Each NAL unit is preceded by 0x000001 (hex) 405 and has an 8-bit header 401 and a payload 403 with the payload type specified by one of the header fields.

The nal_ref_ids field 407 is a 2 bit unsigned integer field in the NAL Header 401. This field indicates if the content of the NAL unit 403 contains a sequence parameter set (SPS), a picture parameter set (PPS) or a slice/slice data partition of a reference picture. The importance of this field is that if a payload is not used as a reference, it can be deemed to be “discardable” which means it does not need to be decoded if it is not needed for display. If nal_{—ref}_idc 407 is equal to 0, this indicates the VCL in the NAL payload 403 is not used as a reference picture, i.e. the NAL payload 403 is discardable. If nal_{—ref}_idc 407 is not equal to 0, this indicates the VCL in the NAL payload 403 is used as a reference picture and may be needed to be able to display other pictures. The AVC standard requires that if nal_{—ref}_idc 407 is equal to 0 for one slice/slice data partition NAL unit in a picture, then it shall be equal to 0 for all slices/slice data partition NAL units of the picture. Therefore, the host only needs to examine this field for the first slice of the picture (and does not need to access this field for all the other slices in a picture) to determine if a picture is discardable.

The nal_{—unit}_type field 409 is a 5 bit unsigned integer field in the NAL Header 401. This field indicates the nature of the NAL payload data 403 and can contain one of the values listed in Table 2. This table also indicates which NAL units should be stored in the AVC start code table.

TABLE 3
Definition of nal_unit type

| | | Store in |
|---|---|---|
| nal_unit_type | Content | Table? |
| 0 | Unspecified | NO |
| 1 | Coded slice of a non-IDR | YES |
| | picture | |
| 2 | Coded slice data partition A | NO |
| | (Extended profile) | |
| 3 | Coded slice data partition B | NO |
| | (Extended profile) | |
| 4 | Coded slice data partition C | NO |
| | (Extended profile) | |
| 5 | Coded slice of an IDR picture | YES |
| 6 | Supplemental enhancement | NO |
| | information (SEI) | |
| 7 | Sequence parameter set (SPS) | YES |
| 8 | Picture parameter set (PPS) | YES |
| 9 | Access unit delimiter (AU) | YES |
| 10 | End of sequence | NO |
| 11 | End of stream | NO |
| 12 | Filler data | NO |
| 13-23 | Reserved | NO |
| 24-31 | Unspecified | NO |

FIG. 5 is a diagram illustrating an exemplary Slice Header 500. Slice Header data is present in the NAL payload 403 if nal_{—unit}_type 409 equals 1 or 5. Three fields in the slice header 500 (first_mb_in_slice 501, slice_type 503 and pic_parameter_set_id 505) need to be captured by the indexing engine.

The first_mb_in_slice field 501 is an unsigned integer field that is variable length coded in the Slice Header 500. In AVC, the maximum number of macroblocks is 8192. In AVC, the worst-case scenario in terms of number of bits for representing this field would be for the last macroblock in the frame (macroblock #8191) to be encoded as a single slice:

$$\begin{matrix}Sizeof ( first\_mb \_in \_slice ) = 1 + 2 * floor [ log 2 ( 8191 + 1 ) ] \\ = 27 bits ( worst case )\end{matrix}$$

The first_mb_in_slice field 501 indicates the address of the first macroblock in the slice. The importance of this field is that it allows the system to know the location of the beginning of each picture in the bitstream. In the AVC standard, picture boundaries are optional. If the address of the first macroblock in the slice is equal to 0, this slice can be determined to be the first slice of the picture and a nonzero value indicates it is not the first slice of the picture.

For PVR purposes, the indexer is interested in whether the slice is the first slice of the picture or not. Therefore, instead of storing the value of first_mb_in_slice 501 for each Slice Header 500 entry in the index table, a Boolean flag may be defined for each entry. For example, the Boolean flag may be set equal to TRUE if first_mb_in_slice 501 is equal to 0 and FALSE if first_mb_in_slice 501 is not equal to 0.

The slice_type field 503 is an unsigned integer field that is variable length coded in the Slice Header. Table 4 lists the possible values for slice_type 503, which indicates the coding type of the slice. The worst-case scenario in terms of number of bits for representing this field would be for the value 9 to be encoded:

$$\begin{matrix}Sizeof ( slice\_type ) = 1 + 2 * floor [ log 2 ( 9 + 1 ) ] \\ = 7 bits ( worst case )\end{matrix}$$

The importance of the slice_type field 503 is it indicates whether reference slices are required to decode this slice. Pulling together all the slice types of a picture lets the host know if that picture requires temporal prediction.

TABLE 4
Definition of slice type

| | Name of |
|---|---|
| slice_type | slice_type |
| 0, 5 | P-slice |
| 1, 6 | B-slice |
| 2, 7 | I-slice |
| 3, 8 | SP-slice |
| 4, 9 | SI-slice |

The pic_parameter_set_id field 505 is an unsigned integer field that is variable length coded in the Slice Header 500. The range of values for this field is 0 to 255, inclusive. In AVC, the worst-case scenario in terms of number of bits for representing this field would be for the value 255 to be encoded:

$$\begin{matrix}Sizeof ( slice\_type ) = 1 + 2 * floor [ log 2 ( 255 + 1 ) ] \\ = 17 bits ( worst case )\end{matrix}$$

The importance of the pic_parameter_set_id field 505 is it indicates the proper Picture Parameter Set (PPS) that should accompany this slice data. The AVC standard requires that the pic_parameter_set_id 505 be the same in all slice headers of the same picture so only the value for the first slice needs to be determined when parsing pictures with multiple slices.

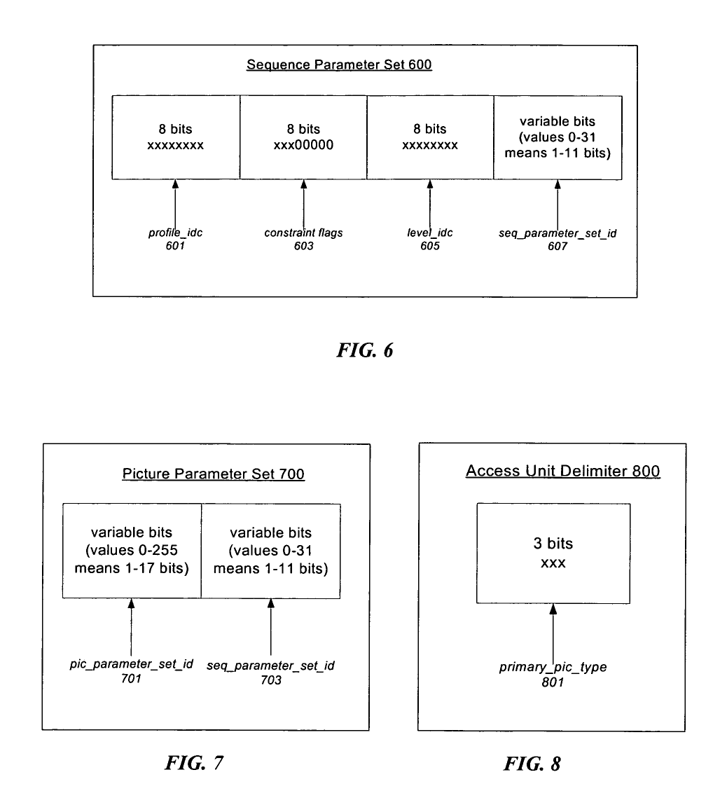

FIG. 6 illustrates indexing of the Sequence Parameter Set (SPS) 600. Sequence Parameter Set (SPS) data is present in the NAL payload 403 if nal_{—unit}_type 409 equals 7. One field (seq_parameter_set_id 607) needs to be captured by the indexing engine.

The seq_parameter_set_id field 607 is an unsigned integer field that is variable length coded in the Sequence Parameter Set. In AVC, the range of values for this field is 0 to 31, inclusive. In AVC, the worst-case scenario in terms of number of bits for representing this field would be for the value 31 to be encoded:

$$\begin{matrix}Sizeof ( slice\_type ) = 1 + 2 * floor [ log 2 ( 31 + 1 ) ] \\ = 11 bits\end{matrix}$$

The importance of this field is it defines the identification number for this NAL unit than the seq_parameter_set_id field 607 in the Picture Parameter Set 600 for another NAL unit can reference.

FIG. 7 illustrates indexing of the Picture Parameter Set (PPS) 700. Picture Parameter Set (PPS) data is present in the NAL payload 403 if nal_{—unit}_type 409 equals 8. Two fields (pic_parameter_set_id 701 and seq_parameter_set_id 703) need to be captured by the indexing engine.

The pic_parameter_set_id field 701 is an unsigned integer field that is variable length coded in the Picture Parameter Set (PPS) 700. In AVC, the range of values for this field is 0 to 255, inclusive. In AVC, the worst-case scenario in terms of number of bits for representing this field would be for the value 255 to be encoded:

$$\begin{matrix}Sizeof ( slice\_type ) = 1 + 2 * floor [ log 2 ( 255 + 1 ) ] \\ = 17 bits ( worst case )\end{matrix}$$

The importance of this field is it defines the identification number for this NAL unit than the pic_parameter_set_id field in the Slice Header for another NAL unit can reference.

The seq_parameter_set_id field 703 is an unsigned integer field that is variable length coded in the Picture parameter Set (PPS) 700. In AVC, the range of values for this field is 0 to 31, inclusive. In AVC, the worst-case scenario in terms of number of bits for representing this field would be for the value 31 to be encoded:

$$\begin{matrix}Sizeof ( slice\_type ) = 1 + 2 * floor [ log 2 ( 31 + 1 ) ] \\ = 11 bits\end{matrix}$$

The importance of this field is it indicates the proper Sequence Parameter Set (SPS) 600 that should accompany this picture data.

FIG. 8 illustrates indexing of the Access Unit Delimiter (AU) 800. Access Unit Delimiter (AU) data is present in the NAL payload 403 if nal_{—unit}_type 409 equals 9. The transmission of AU data is optional and not required by the AVS standard. One field (primary_pic_type 801) needs to be captured by the indexing engine.

The primary_pic_type field 801 is a 3 bit unsigned integer field in the NAL Header. This field indicates the type of slices present in the coded picture of the next NAL unit and contains one of the values listed in Table 5.

TABLE 5
Definition of primary_pic_type

| primary_pic_type | slice_type_values that may be present |
|---|---|
| 0 | I |
| 1 | I, P |
| 2 | I, P, B |
| 3 | SI |
| 4 | SI, SP |
| 5 | I, SI |
| 6 | I, SI, P, SP |
| 7 | I, SI, P, SP, B |

The importance of this field is that it contains the AVS equivalent of the MPEG-2 picture_coding_type field.

The AVC start code table may support a programmable range of start codes. This allows for all NAL headers in AVC to be flagged and recorded without a change to hardware. Table 6 lists the worst-case number of bits that need to be captured in the AVC start code table.

TABLE 6
Worst case number of bits that need to be captured

| nal_unit_type | Bits required (including the NAL Header) |
|---|---|
| 1, 5 (Slice | 59 |
| Header) | |
| 6 (SEI) | 8 |
| 7 (SPS) | 43 |
| 8 (PPS) | 36 |
| 9 (AU) | 11 |

Therefore, the worst-case number of bits required to capture after the 0x000001 prefix of a NAL unit is 59 bits when the NAL unit is a Slice Header.

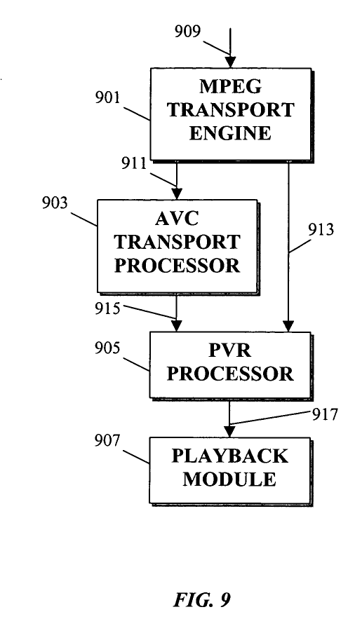

FIG. 9 is a diagram illustrating an exemplary system for constructing an AVC start code table. The system comprises an MPEG transport engine 901, an AVC transport processor 903, a PVR processor 905, and a playback module 907.

The MPEG transport engine 901 examines video data 909 the presence of an Advanced Video Coding (AVC) Network Abstraction Layer (NAL) unit. The MPEG transport engine 901 examines a NAL header associated with the NAL unit. If the video data 909 is not an AVC NAL unit, the video data 909 is directed to the PVR processor 905 to be displayed on the playback module 907.

If the video data 909 is an AVC NAL unit, the video data 909 is directed to the AVC transport processor 903. The AVC transport processor 903 generates and stores an MPEG-4 start code table 915. The AVC transport processor 903 may by software or hardware. The MPEG-4 start code table 915 comprises at least one starting address for at least one data structure such as a slice. The AVC transport processor 903 may determine the appropriate SPS and PPS data that accompany the slice. The AVC transport processor 903 may also determines picture type based on examining the NAL unit. The picture type may be one of an I-picture, a B-picture, or a P-picture. The AVC transport processor 903 may also determine if each picture is required for temporal prediction. The MPEG-4 start code table 915 is sent to the PVR processor 905 to assist in PVR applications where the output of trick mode operations may be displayed on the playback module 907.

If the video data 909 contains MPEG-2 content, the MPEG transport engine 901 may detect codes that directly form an MPEG-2 start code table 913. The MPEG-4 start code table 915 and the MPEG-2 start code table 913 may be equivalent. By using a common start code format, the functionality of the PVR processor 905 may be common to both MEPG-2 and MPEG-4.

The present invention is not limited to the particular aspects described. Variations of the examples provided above may be applied to a variety of processors without departing from the spirit and scope of the present invention.

Accordingly, the present invention may be realized in hardware, software, or a combination of hardware and software. The present invention may be realized in a centralized fashion in an integrated circuit or in a distributed fashion where different elements are spread across several circuits. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for reconstructing MPEG-2 start codes from AVC data, wherein the method comprises:
examining data in an Advanced Video Coding (AVC) Network Abstraction Layer (NAL) unit;
generating a table for the NAL unit, said table comprising at least one starting address for at least one data structure; and
writing said table to memory.

2. The method of claim 1, wherein the at least one data structure comprises a slice.

3. The method of claim 1, wherein generating the table further comprises determining picture type based on examining the NAL unit.

4. The method of claim 3, wherein the picture type is one of an I-picture, a B-picture, or a P-picture.

5. The method of claim 1, wherein examining the NAL unit further comprises examining a NAL header associated with the NAL unit.

6. The method of claim 1, wherein the method further comprises determining if each picture is required for temporal prediction.

7. The method of claim 1, wherein the method further comprises determining the appropriate SPS and PPS data that accompanies every slice.

8. A system for reconstructing MPEG-2 start codes from AVC data, wherein the system comprises:
an engine for examining data for the presence of an Advanced Video Coding (AVC) Network Abstraction Layer (NAL) unit;
a processor for generating and storing a table when the NAL unit is present, said table comprising at least one starting address for at least one data structure.

9. The system of claim 8, wherein the engine examines a NAL header associated with the NAL unit.

10. The system of claim 8, wherein the processor determines picture type based on examining the NAL unit.

11. The system of claim 10, wherein the picture type is one of an I-picture, a B-picture, or a P-picture.

12. The system of claim 11, wherein the processor determines if each picture is required for temporal prediction.

13. The system of claim 8, wherein the at least one data structure comprises a slice.

14. The system of claim 9, wherein the processor determines the appropriate SPS and PPS data that accompanies the slice.
